(19) United States
(12) Patent Application Publication
(10) Pub. No.: US 2014/0115683 A1
(43) Pub. Date: Apr. 24, 2014

(54) SYSTEMS AND METHODS FOR PEER-TO-PEER ONLINE VERIFICATION USING THIRD PARTY AUTHENTICATION

(71) Applicants: Adam Stass, Houston, TX (US); Dustin Yu, Houston, TX (US)

(72) Inventors: Adam Stass, Houston, TX (US); Dustin Yu, Houston, TX (US)

(21) Appl. No.: 14/057,870

(22) Filed: Oct. 18, 2013

Related U.S. Application Data
(60) Provisional application No. 61/715,776, filed on Oct. 18, 2012.

(51) Int. Cl. H04L 29/06

(52) U.S. Cl. CPC H04L 63/0884
USPC 726/9

(57) ABSTRACT

The present disclosure is directed to methods and systems for indicating bias-less trust levels to online users for the purpose of facilitating safe and secure online purchase transactions within an online community.

### CROSS-REFERENCE TO RELATED APPLICATION

This application claims the benefit of U.S. Provisional Application No. 61/715,776, which was filed on Oct. 18, 2012 and is incorporated herein by reference in its entirety.

### FIELD

The present disclosure is directed to methods and systems for indicating bias-less trust levels to online users for the purpose of facilitating safe and secure online purchase transactions within an online community.

### BACKGROUND

Various services exist for identifying and measuring the reliability of an online user within a community. For example, eBay, Yelp, and various other sites utilize a feedback rating system which is submitted by peers who are involved in a transaction (buyer vs. seller, restaurant vs patron). This rating system is flawed due to fraud and biases by the reviewer which may or may not be true actual outcome. Fraudulent ratings can easily be conjured by creating fake transactions, and giving high ratings to fraudulent accounts. In another example, within eBay, a disgruntled reviewer may have given a bad rating for an item purchased when they find out it is broken, but seller has indicated this clearly in the description—in which it is the buyers fault for not reading a description fully. These type of misunderstandings do not produce 100% accurate rating results of the transactions and are entirely subjective. Using a feedback ratings-based system is not ideal in validating the true authenticity of a user.

### BRIEF DESCRIPTION OF THE DRAWINGS

FIG. 1: Settings: Verification System—Each 3^{rd} party service that you log into sends an authentication token back to the online application. Now we can allow the other party to know that you are verified via these methods.

FIG. 2: Settings: Verify Phone Number—To verify your phone number, you will be prompted to enter your mobile phone number. A free text message is sent to your mobile phone with a unique 4 digit PIN number. By entering the matching 4 digit PIN number into the online application, this will verify your mobile phone as legitimate.

FIG. 3: Verify Amazon—Logging in with your Amazon Payments credentials will communicate with the online application to indicate that you have verified with Amazon Payments.

FIG. 4: Verify Paypal—Logging in with your PayPal credentials will communicate with the online application to indicate that you have verified with Paypal Payments.

FIG. 5: Verify Facebook—Logging in with your Facebook credentials will communicate with the online application to indicate that you have verified with Facebook.

FIG. 6: Verify Twitter—Logging in with your Twitter credentials will communicate with the online application to indicate that you have verified with Twitter.

FIG. 7 is a schematic block diagram of an exemplary computing system on which certain embodiments of the systems and methods disclosed herein can be implemented.

FIG. 8 is a block diagram illustrating a computer network that can be used to perform at least some of the embodiments of the systems and methods disclosed herein.

FIG. 9 is a block diagram illustrating another computer network that can be used to perform at least some of the embodiments of the systems and methods disclosed herein.

FIG. 10 is a block diagram illustrating how the computer networks of FIG. 8 or 9 can be used to perform certain aspects of the systems and methods disclosed herein.

### DETAILED DESCRIPTION

General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Traditional ratings-based systems as described above are flawed in the sense that the results can be biased—either through fraudulent manipulation, or misunderstandings between 2 parties. Now, using Peer-To-Peer Online Verification Using 3^{rd} Party Authentication, there is no doubt as to the level of verification a user has. The verification level is either verified or not.

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

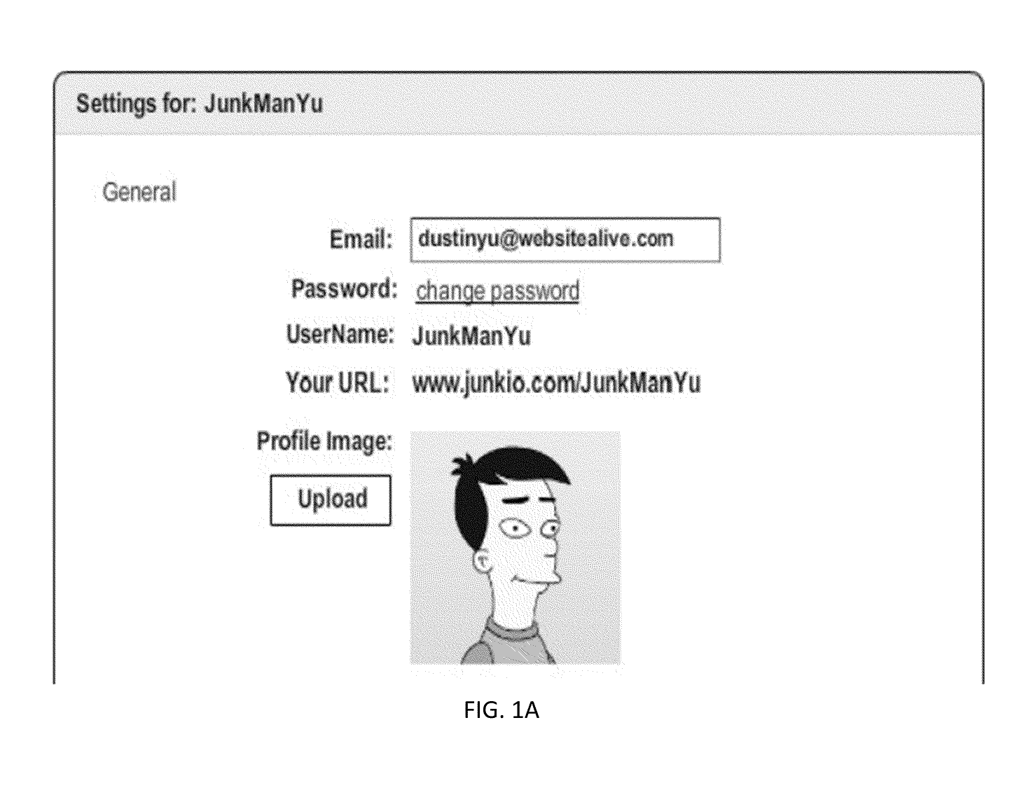

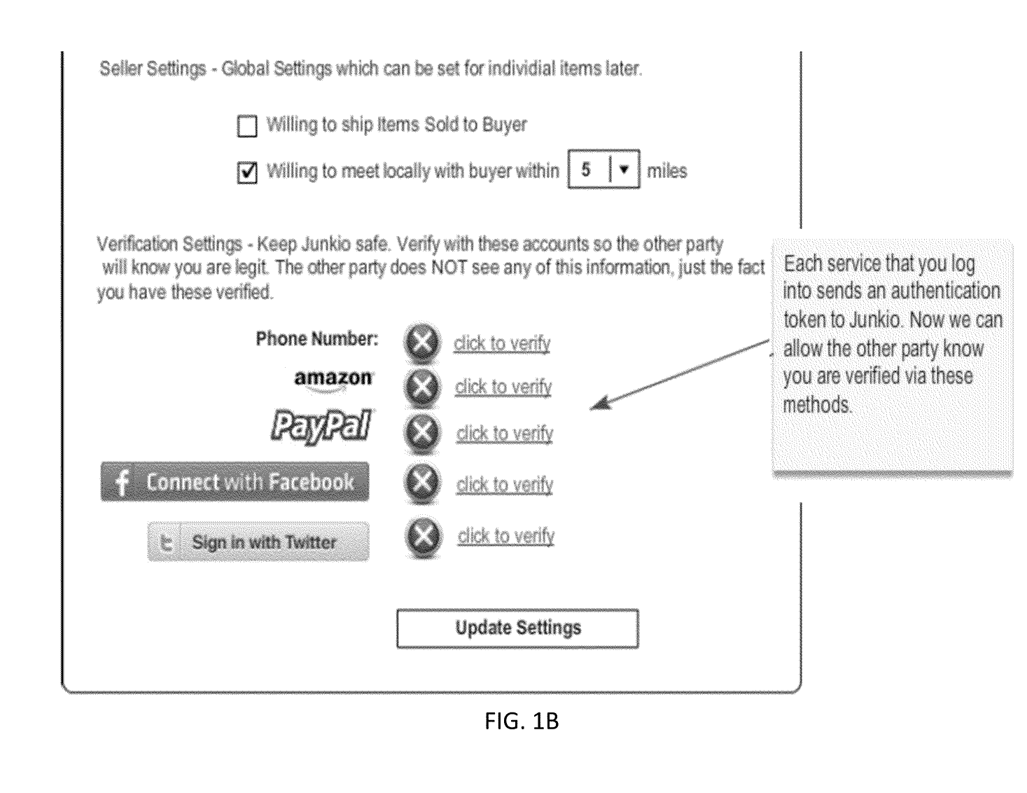

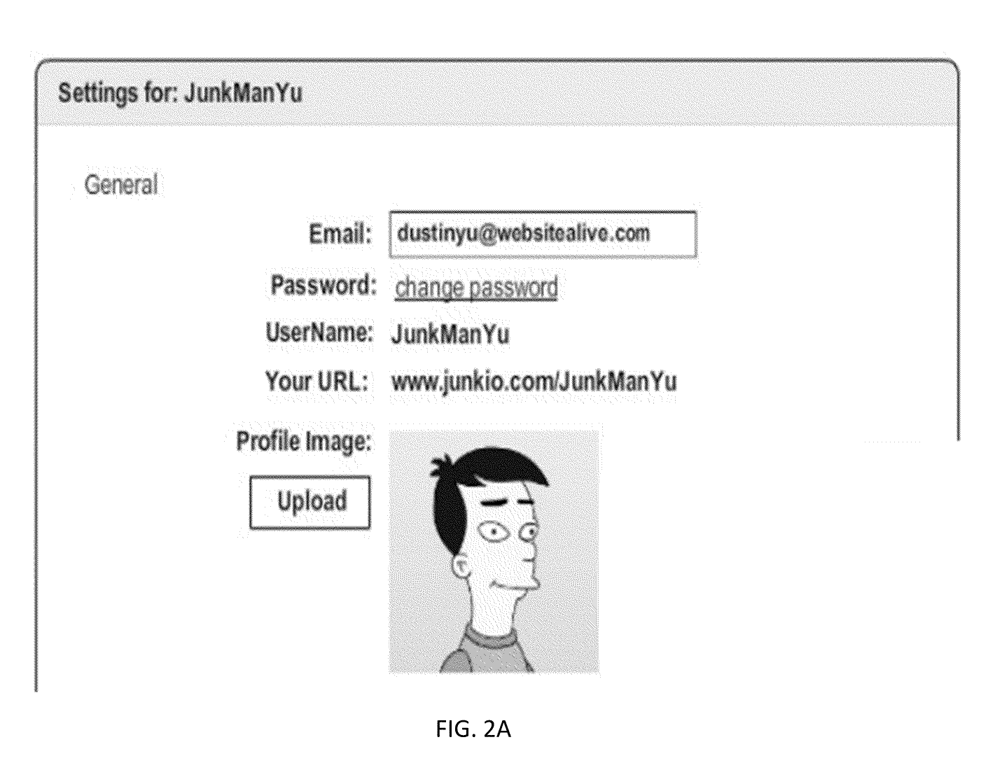

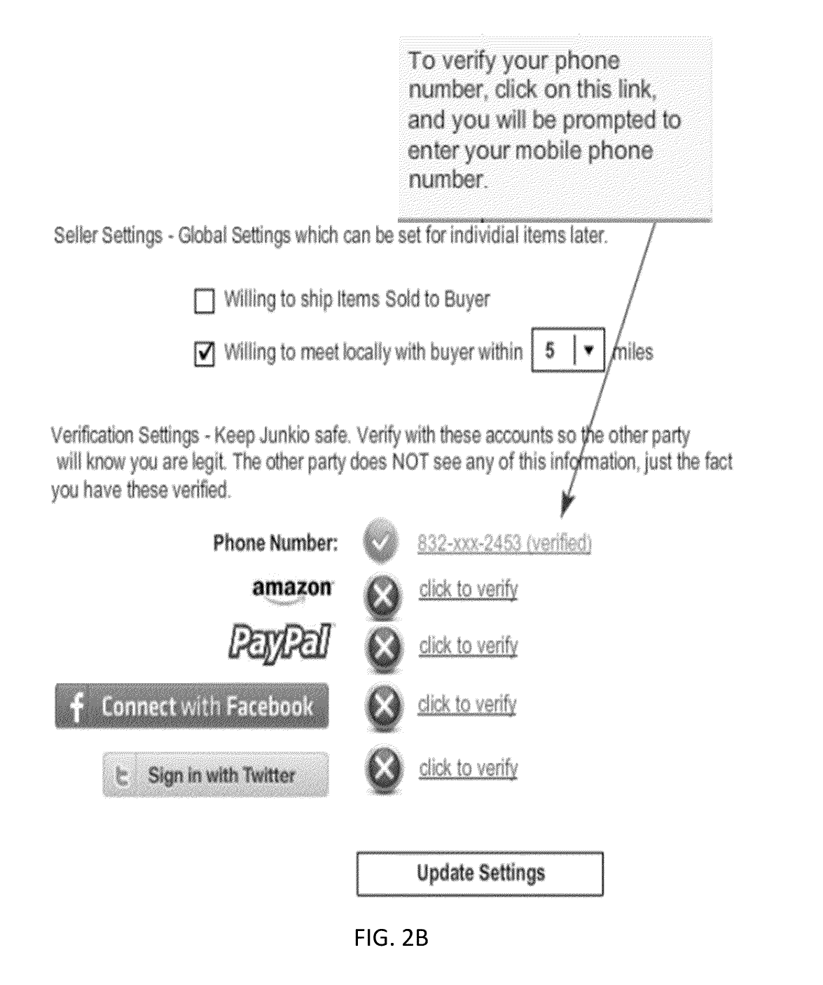

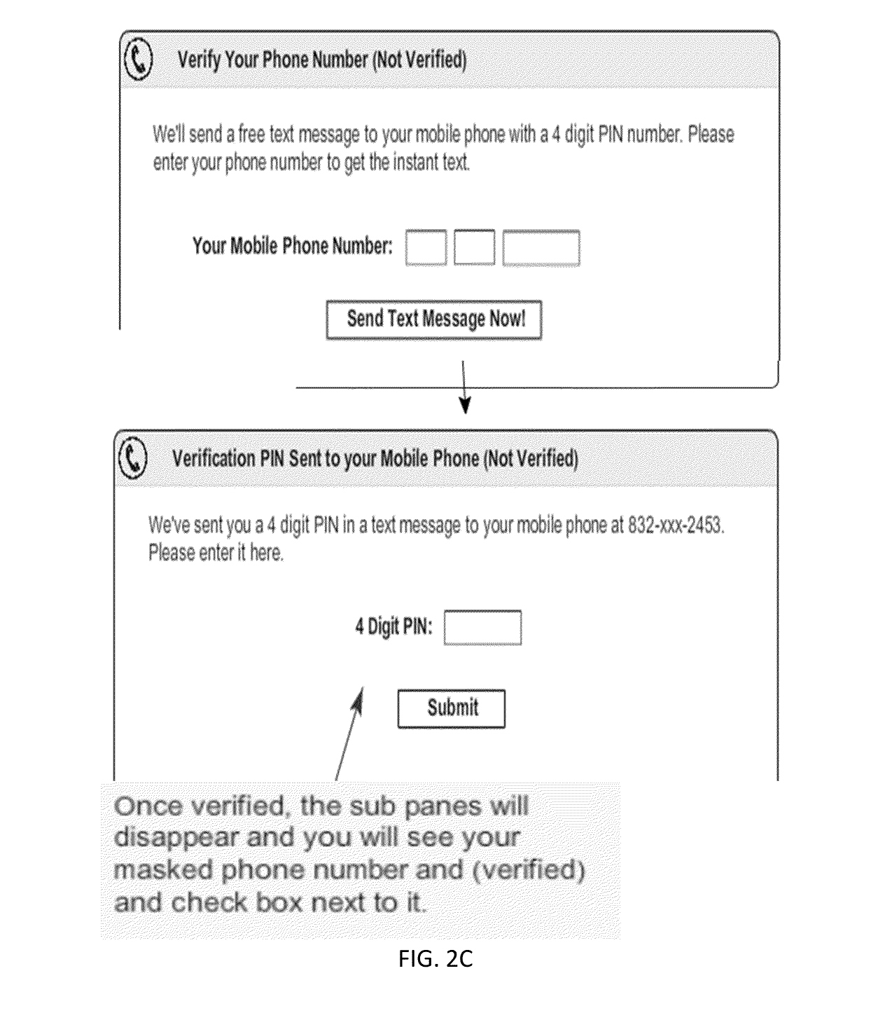

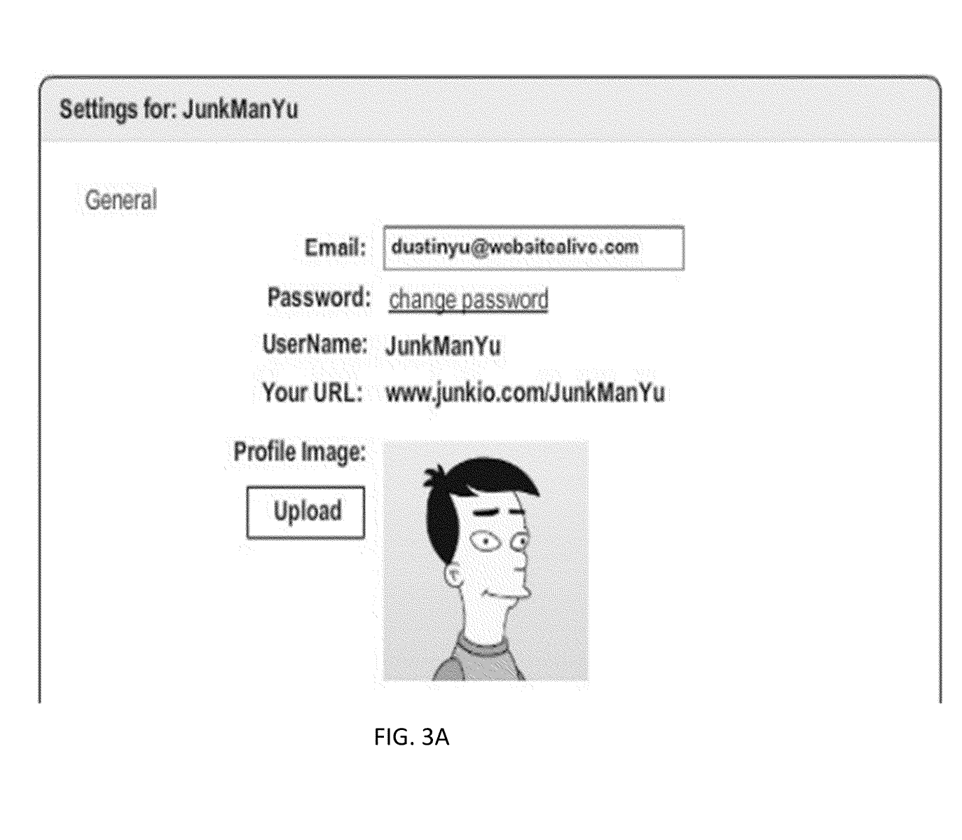

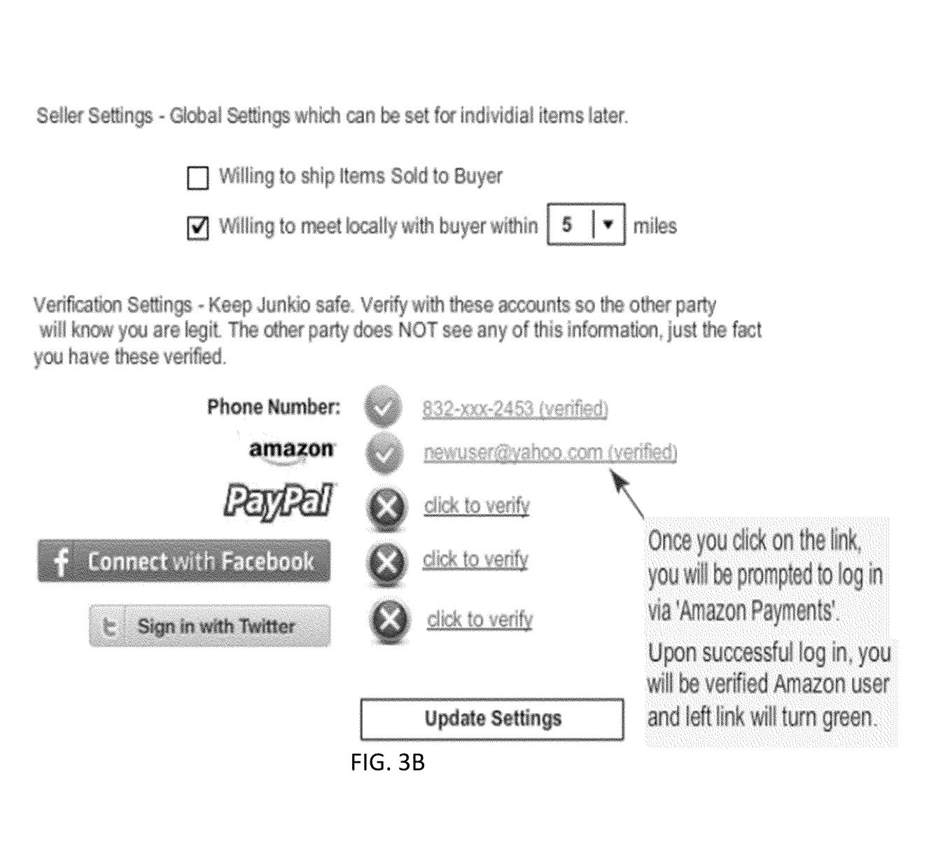

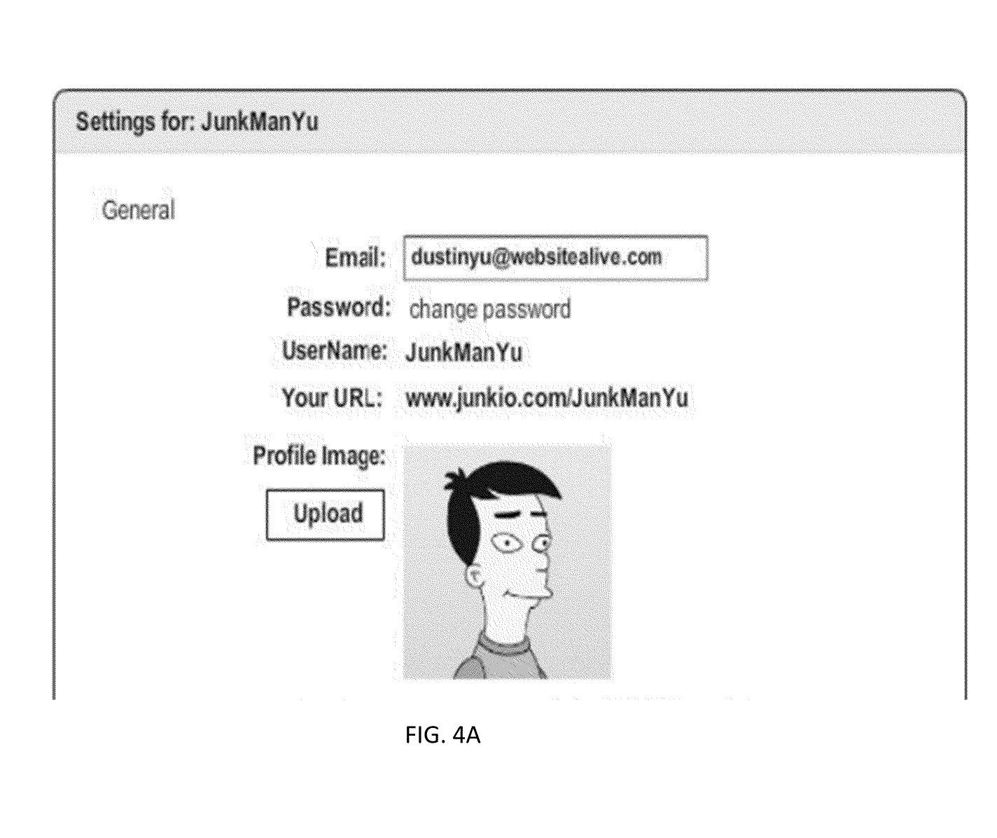

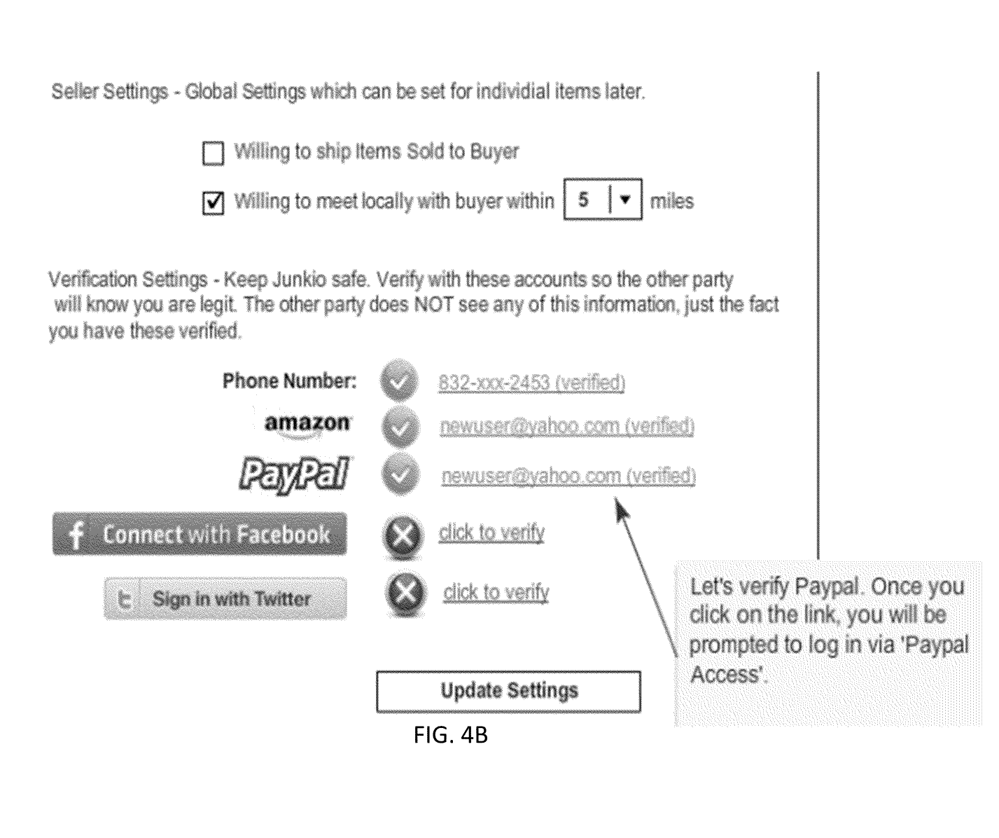

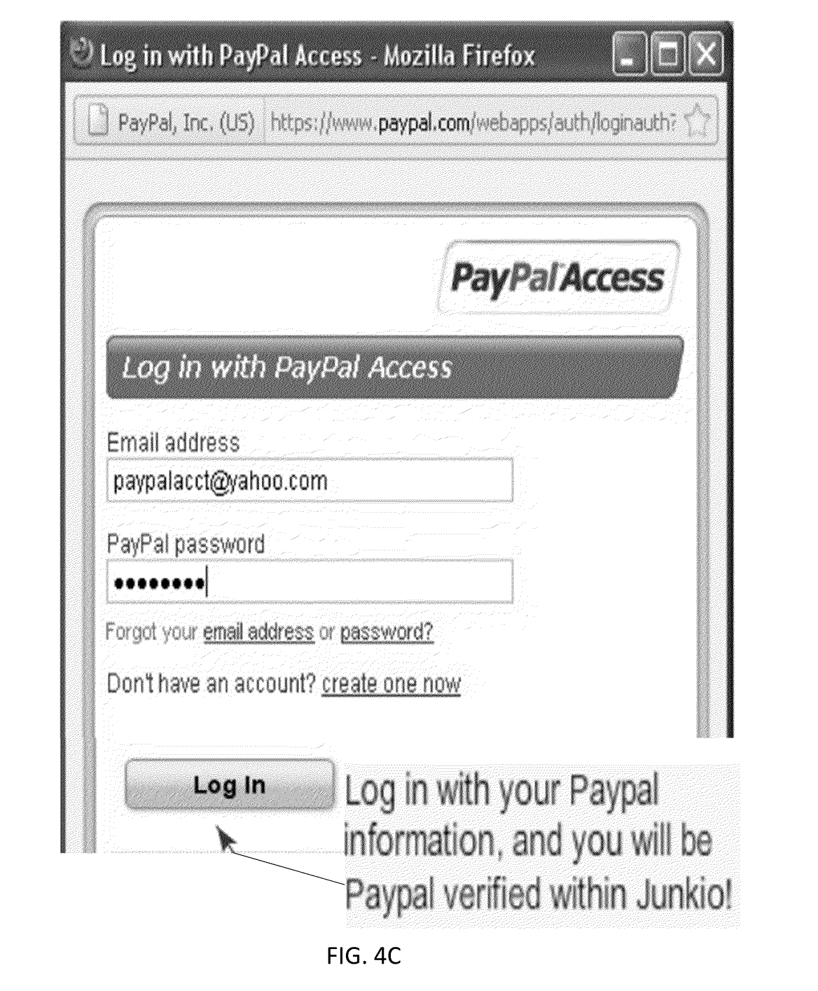

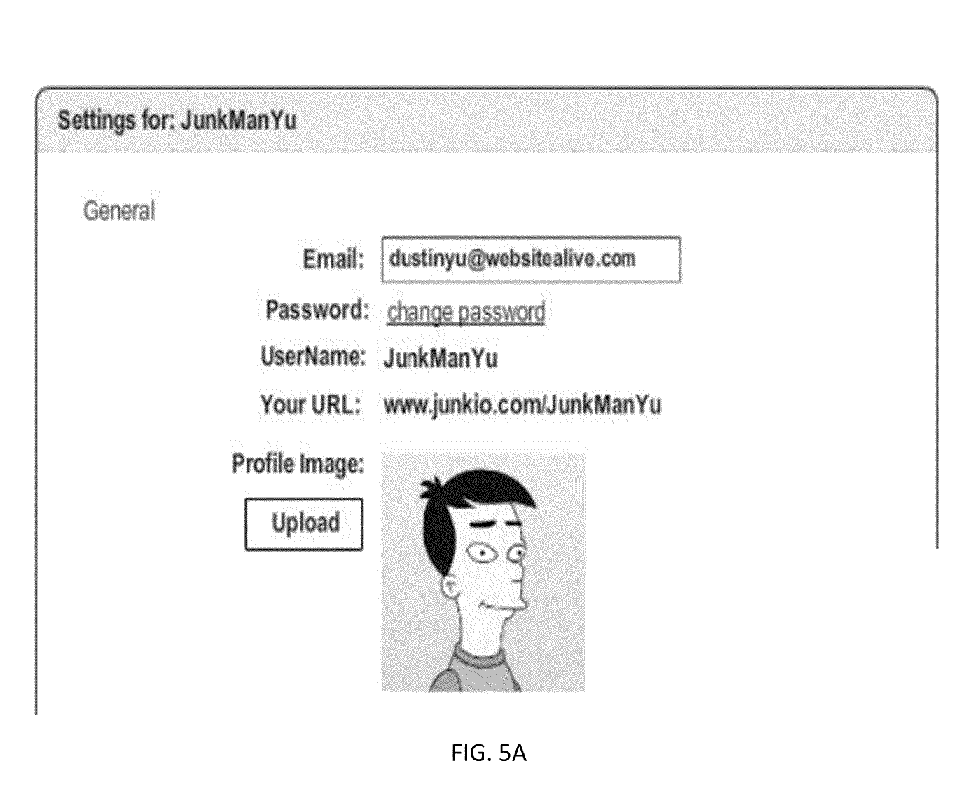

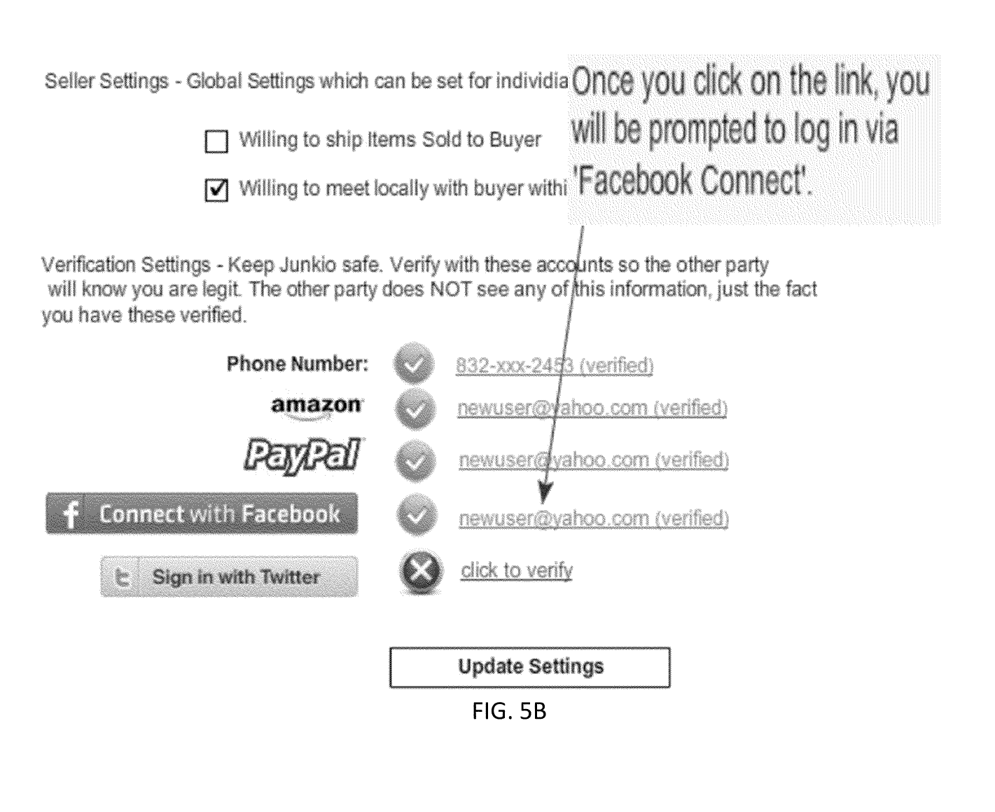

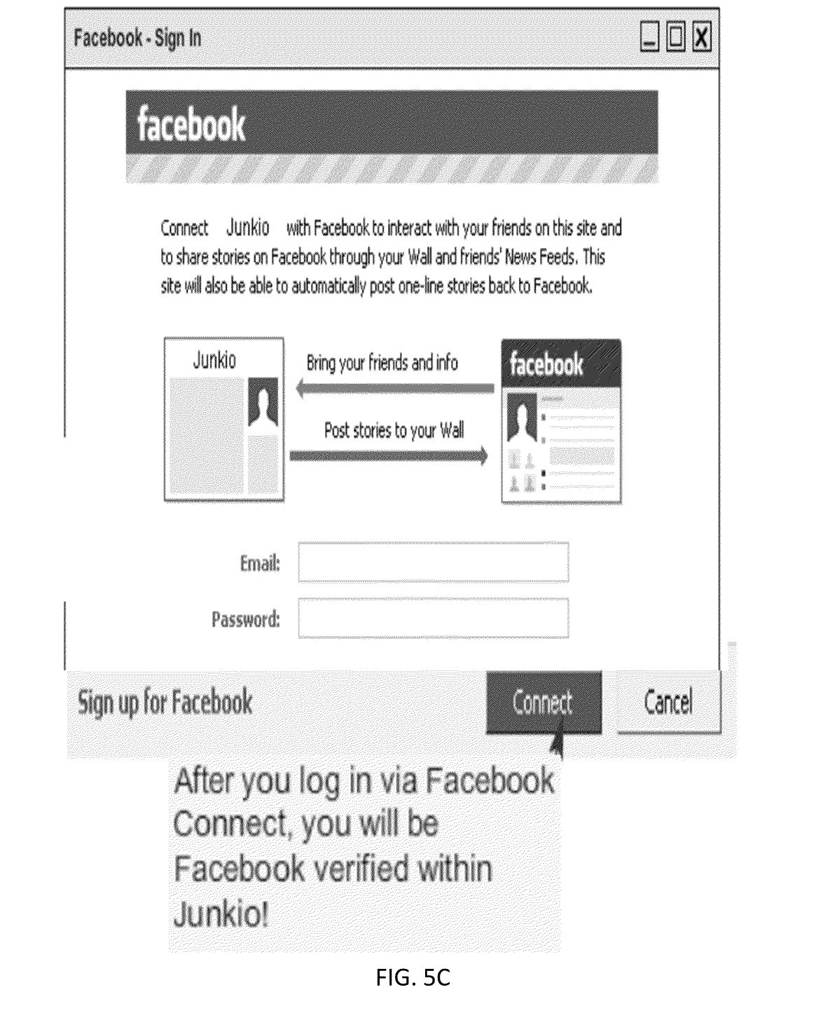

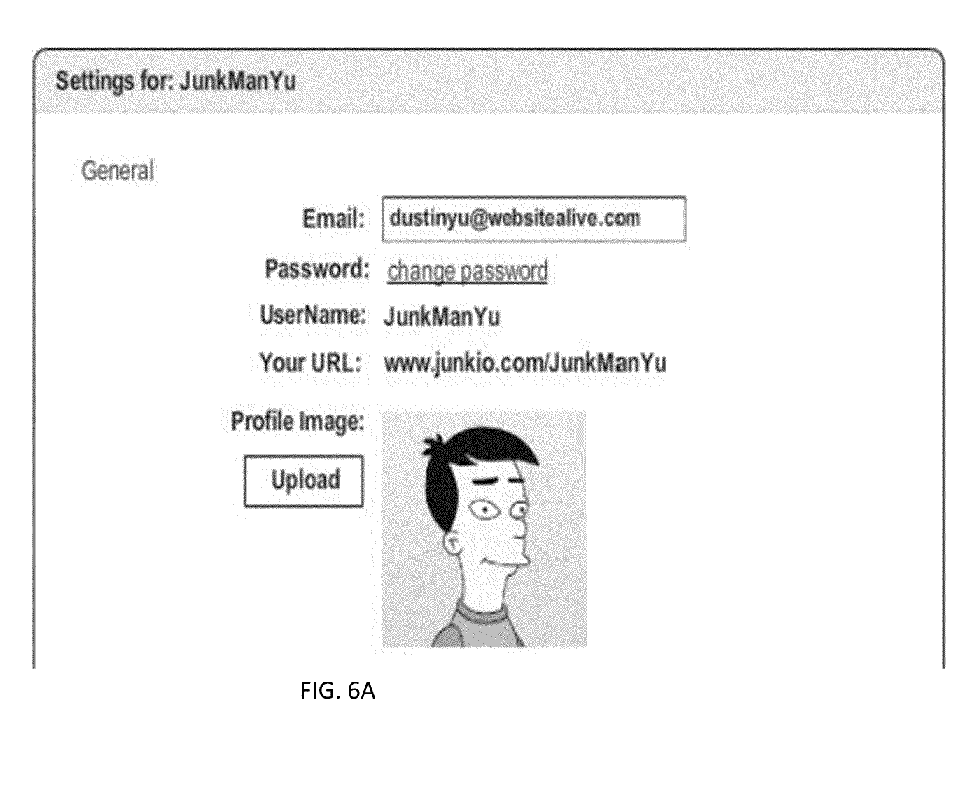

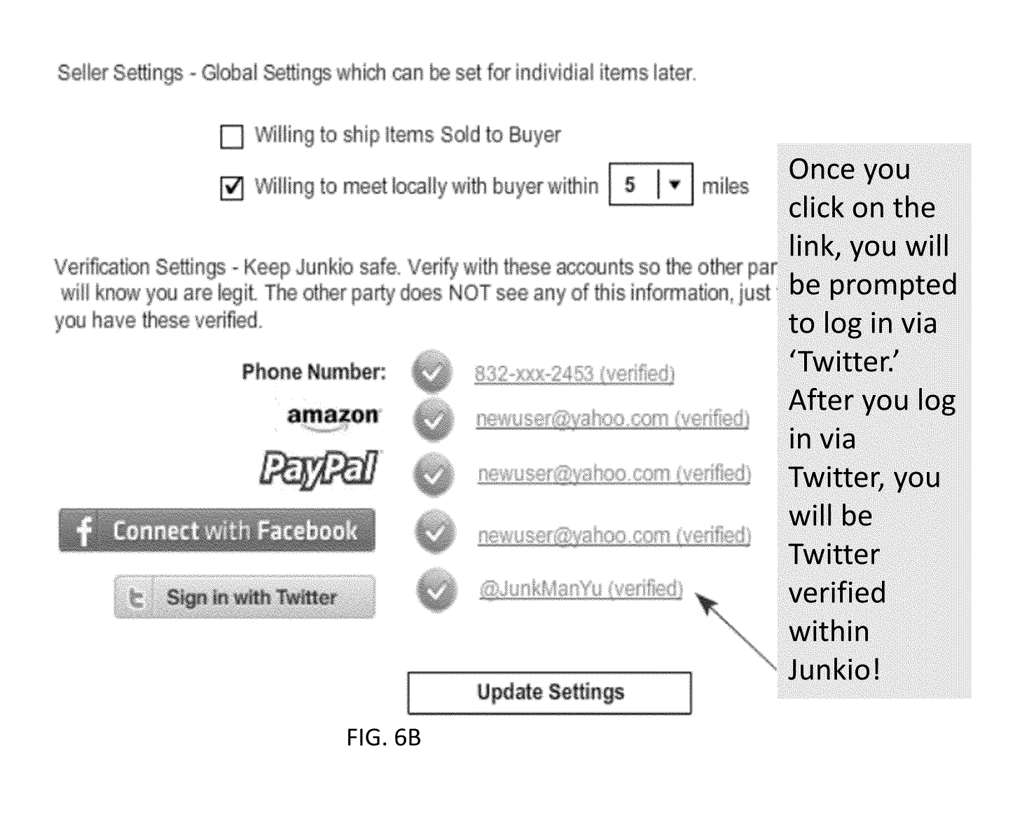

Overview—To start with the verification process, FIGS. 1-6 show the backend interface viewed by the account owner (YOU) who wants to verify with different 3^{rd} party services you may have accounts to so as to display to other users your level of verification. When online users view your profile, a list of verifications you've completed will appear as icons. For each service you have verified in the backend settings, the front end will show an icon relating to that service. Specific user details of the verified service are not disclosed, just the fact that you have verified this service will allow the opposite user gauge your identity which will help them decide whether to transact with you. This is done securely, as your user details are not exposed. The public interface is where other users can see the level of verification you have achieved from the backend interface.

System Description—For each method of verification, it requires an API (application program interface) in which our online application can interact with the respective 3^{rd} party application such as Amazon, Facebook, Twitter, etc. This interaction is based on opening a login window which is hosted by the 3^{rd} party's servers, which opened from our online website, allows the user to log in. Once logged in, an authentication token is sent back from the 3^{rd} party, which is saved in our online site, which indicates that the user has validated that system, without the transfer of any specific username or password. This authentication token is a “reference” to that 3^{rd} party service.

Exemplary Methods of Operation

In these following “real-world” examples, I will describe the experiences of 2 types of users, the “seller” and “buyer”.

Example 1: “Seller” is in their settings panel on a hypothetical web site and has the option of verifying 3 sections—mobile phone number, Amazon, and Facebook. To verify their mobile number, they receive a text message from the site with a security code. Once they enter in that code to the site, they have obtained mobile phone verification status. Then, the “seller” continues onto Amazon verification. They click on a button on the site to start verification, which opens up a pop up window to Amazon's login page. They then log in with their Amazon credentials, which once authenticated, sends a response back to the site, which then the site records this response as a successful authentication of this “seller's” Amazon login. Finally, the “seller” proceeds to verify their Facebook account. They click on a button on the site which opens a pop up window to Facebook's login page. They log in with their Facebook credentials, which once authenticated, sends a response back to the site, which then the site records this response as a successful authentication of this “seller's” Facebook login. The “seller” has completed all 3 types of verification methods available in this hypothetical site, and no confidential information is transferred to the site—only a token. Now, for the “buyer's” point of view. When the “buyer” is interested in finding out more about this “seller”, they view the “seller's” verification status and they see that they have fully 3 types of verification methods passed. Although their specific user account information for each type of verification is not shown (i.e. mobile number, Amazon email, Facebook username), they do however see a graphical marker or icon indicating that they are successfully authenticated. This will allow the “buyer” to instantly gauge the reliability and authenticity of the “seller” via this black and white method, rather than relying on other feedback mechanisms which is biased and or manipulated due to user generation.

Example 2: In this example, the “seller” only verifies their mobile phone number in the same method as in Example 1. They skip the Amazon and Facebook verification. For the “buyer” point of view, when they view the “seller's” verification status, they only see that the mobile phone number is verified, but not the Amazon or Facebook account. This information will help them decide whether or not to do business with this “seller” as they may be another “seller” who as a higher number of verified methods such as in Example 1 in which they prefer to work with.

Implementation of the Systems and Methods Disclosed Herein

The systems may be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

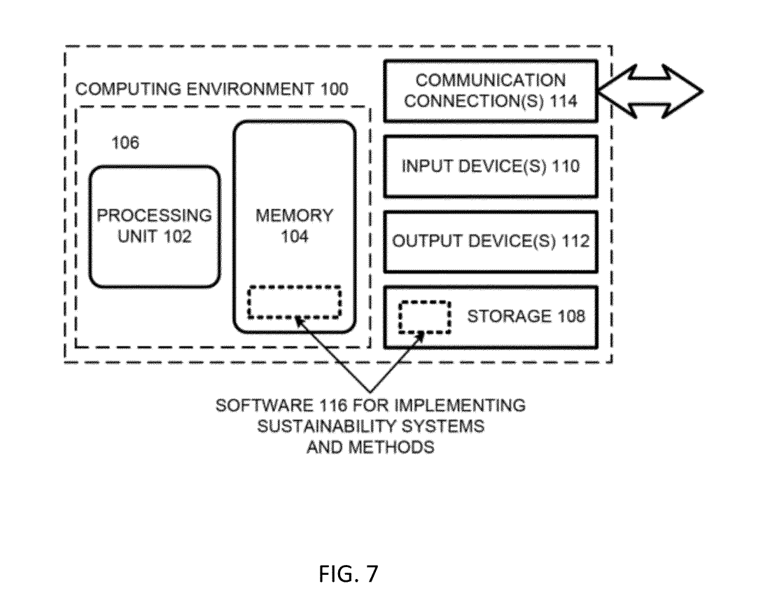

FIG. 7 illustrates a generalized example of a suitable computing environment 100 in which several of the described embodiments can be implemented. The computing environment 100 is not intended to suggest any limitation as to scope of use or functionality, as the methods described herein can be implemented in diverse general-purpose or special-purpose computing environments.

With reference to FIG. 7, the computing environment 100 includes at least one processing unit 102 and memory 104. In FIG. 7, this most basic configuration 106 is included within a dashed line. The processing unit 102 executes computer-executable instructions and may be a real or a virtual processor. In a multi-processing system, multiple processing units execute computer-executable instructions to increase processing power. The memory 104 may be volatile memory (e.g., registers, cache, RAM), non-volatile memory (e.g., ROM, EEPROM, flash memory, etc.), or some combination of the two. The memory 104 stores software 116 implementing one or more of the systems described herein.

The computing environment may have additional features. For example, the computing environment 100 includes storage 108, one or more input devices 110, one or more output devices 112, and one or more communication connections 114. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 108 may be removable or non-removable, and includes magnetic disks, magnetic tapes or cassettes, CD-ROMs, DVDs, or any other medium which can be used to store information and which can be accessed within the computing environment 100. The storage 108 can store instructions for the software 116 implementing any of the described systems and methods.

The input device(s) 110 can be a touch input device such as a keyboard, mouse, pen, or trackball, a voice input device, a scanning device, or another device that provides input to the computing environment 100. For audio or video encoding, the input device(s) 110 can be a sound card, video card, TV tuner card, or similar device that accepts audio or video input in analog or digital form, or a CD-ROM or CD-RW that reads audio or video samples into the computing environment 100. The output device(s) 112 can be a display, printer, speaker, CD-writer, or another device that provides output from the computing environment 100.

The communication connection(s) 114 enable communication over a communication medium to another computing entity. The communication medium is not a storage medium but conveys information such as computer-executable instructions, resource and construction project information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The various methods disclosed herein can be described in the general context of computer-readable media. Computer-readable media are any available media that can be accessed within or by a computing environment. By way of example, and not limitation, with the computing environment 100, computer-readable media include tangible computer-readable storage media such as memory 104 and storage 108.

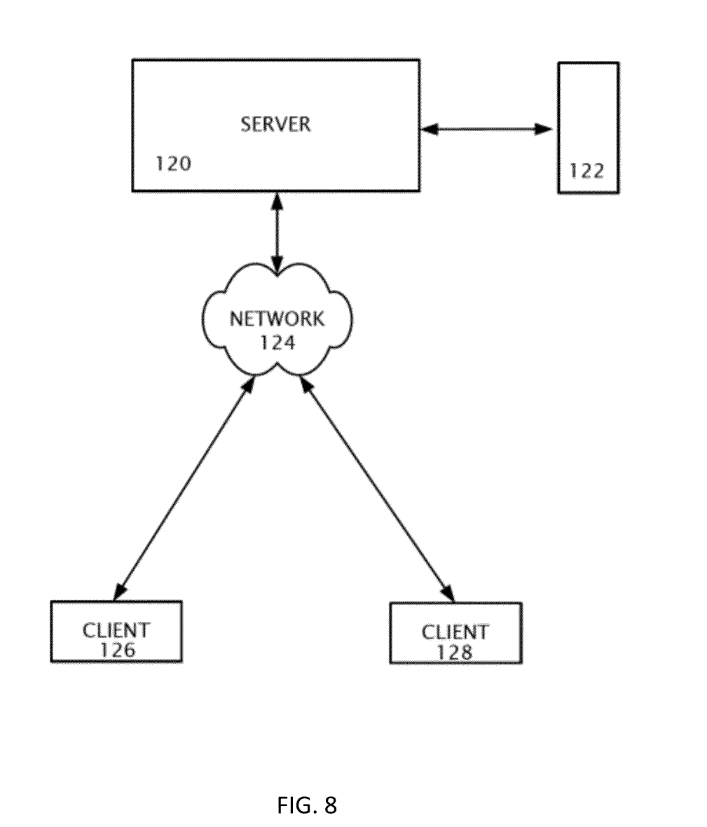

Any of the aspects of the technology described herein can also be performed using a distributed computer network. FIG. 8 shows a simplified embodiment of one such exemplary network. A server computer 120 can have an associated storage device 122 (internal or external to the server computer). For example, the server computer 120 can be configured to perform the calculations and analysis of information according to any of the disclosed embodiments. The server computer 120 can be coupled to a network, shown generally at 124, which can comprise, for example, a wide-area network, a local-area network, a client-server network, the Internet, or other such network. One or more client computers, such as those shown at 126, 128, may be coupled to the network 124 using a network protocol. The work may also be performed on a single, dedicated workstation, which has its own memory and one or more CPUs.

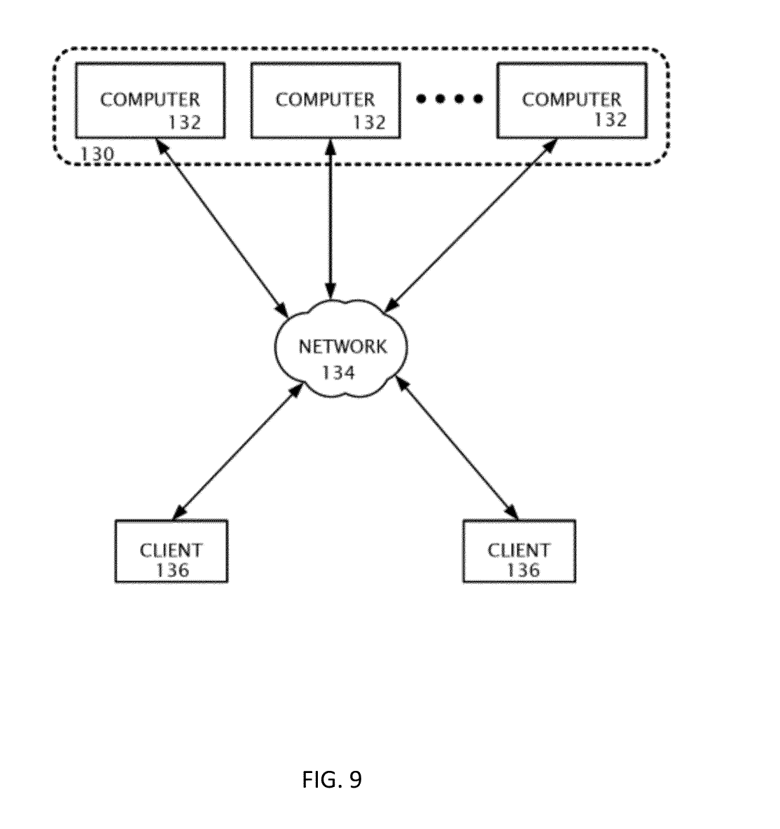

FIG. 9 shows another exemplary network. One or more computers 132 communicate via a network 1304 and form a computing environment 130 (e.g., a distributed computing environment). Each of the computers 132 in the computing environment 130 can be used to perform at least a portion of the calculation techniques according to any of the disclosed embodiments. The network 134 in the illustrated embodiment is also coupled to one or more client computers 136.

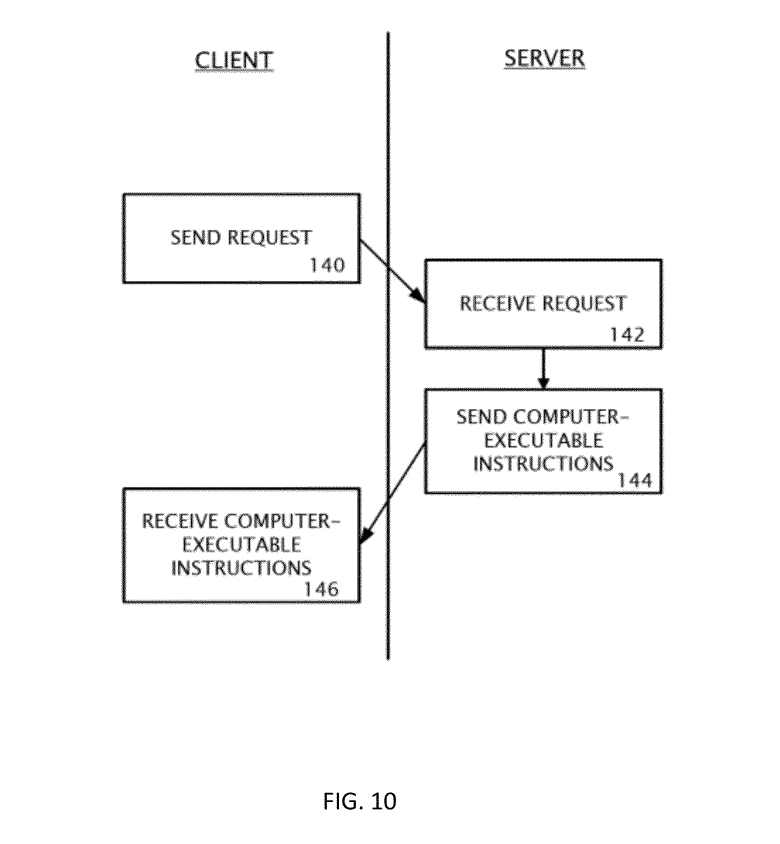

FIG. 10 shows one exemplary manner in which computer-executable instructions for performing any of the disclosed embodiments can be transmitted, accessed, or received using a remote server computer (such as the server computer 120 shown in FIG. 8) or a remote computing environment (such as the computing environment 130 shown in FIG. 9). At process block 140, for example, the client computer sends a request to download computer-executable instructions for performing any of the disclosed methods or techniques (e.g., after registering or logging in to the system). In process block 142, the request is received by the remote server or by respective components of the remote computing environment. In process block 144, the remote server or computing environment transmits computer-executable instructions for performing any of the disclosed methods or techniques. At 146, the computer-executable instructions are received (e.g., stored, buffered, and/or executed) by the client computer.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for verifying an identity of a user, the method comprising:
registering the user with a verification service by receiving information about the user across a computer network;
verifying the identity of the user, wherein the verification includes the steps of:
offering a plurality of verification options for the user;
receiving a selection from the user of at least one verification option from the plurality of verification options; and
receiving an authentication token from a third party that verifies the identity of the user based on information provided by the user to the third party.

2. The method of claim 1, wherein the verification options include at least one of the following, the confirmation of a mobile phone number or the confirmation of a registered online account with a third party.

3. One or more computer-readable storage media storing computer-executable instructions for causing a computer to perform a method, the method comprising:
registering the user with a verification service by receiving information about the user across a computer network;
verifying the identity of the user, wherein the verification includes the steps of:
offering a plurality of verification options for the user;
receiving a selection from the user of at least one verification option from the plurality of verification options; and
receiving an authentication token from a third party that verifies the identity of the user based on information provided by the user to the third party.

4. The media of claim 3, wherein the verification options include at least one of the following, the confirmation of a mobile phone number or the confirmation of a registered online account with a third party.
